(19) United States
(12) Patent Application Publication
(10) Pub. No.: US 2014/0366624 A1
(43) Pub. Date: Dec. 18, 2014

(54) Spacer for a Thermal, Flow Measuring Device

(71) Applicant: Endress + Hauser Flowtec AG, Reinach (CH)

(72) Inventors: Tobias Baur, Reinach (CH); Fanos Christodoulou, London (GB); Martin Barth, Basel (CH); Axel Pfau, Aesch (CH)

(21) Appl. No.: 14/366,836

(22) PCT Filed: Nov. 22, 2012
(86) PCT No.: PCT/EP2012/073359

§ 371 Date: Jun. 19, 2014

(30) Foreign Application Priority Data
Dec. 22, 2011 (DE) 10 2011 089 596.5
Dec. 22, 2011 (DE) 10 2011 089 597.3

(51) Int. Cl. G01F 1/684; B23K 1/00; G01F 1/692

(52) U.S. Cl. CPC G01F 1/6842; G01F 1/692; B23K 1/0008
USPC 73/204.26; 228/256

(57) ABSTRACT

A spacer for a thermal, flow measuring device, wherein the spacer has a planar bearing surface for a thin-film resistance thermometer and an otherwise circularly cylindrical, lateral surface, wherein the bearing surface is inclined relative to a longitudinal axis of the spacer.

The present invention relates to a spacer for a thermal, flow measuring device, which has a planar bearing surface for a thin-film resistance thermometer and an otherwise circularly cylindrical, lateral surface. The terminology, bearing surface, is used here to indicate that such surface is intended to bear, or carry, the thin-film resistance thermometer.

Conventional thermal, flow measuring devices usually use two as equally as possible embodied temperature sensors, which are arranged, most often, in pin-shaped, metal sleeves, so-called stingers, and which are in thermal contact with the medium flowing through a measuring tube or through the pipeline. For industrial application, the two temperature sensors are usually installed in a measuring tube; the temperature sensors can, however, also be mounted directly in a pipeline. One of the two temperature sensors is a so-called active temperature sensor, which is heated by means of a heating unit. The heating unit is either an additional resistance heater or else the temperature sensor itself in the form of a resistance element, e.g. an RTD—(Resistance Temperature Device) sensor, which is heated by conversion of electrical power, e.g. by a corresponding variation of the electrical current used for measuring. The second temperature sensor is a so-called passive temperature sensor: It measures the temperature of the medium.

Usually, in a thermal, flow measuring device, the heatable temperature sensor is so heated that a fixed temperature difference is established between the two temperature sensors. Alternatively, it is also known to supply a constant heating power via a control unit.

If there is no flow in the measuring tube, then an amount of heat constant with time is required for maintaining the predetermined temperature difference. If, in contrast, the medium to be measured is moving, the cooling of the heated temperature sensor is essentially dependent on the mass flow of the medium flowing past. Since the medium is colder than the heated temperature sensor, the flowing medium transports heat away from the heated temperature sensor. In order thus in the case of a flowing medium to maintain the fixed temperature difference between the two temperature sensors, an increased heating power is required for the heated temperature sensor. The increased heating power is a measure for the mass flow of the medium through the pipeline.

If a constant heating power is supplied, then, as a result of the flow of the medium, the temperature difference between the two temperature sensors lessens. The particular temperature difference is then a measure for the mass flow of the medium through the pipeline, respectively through the measuring tube. There is, thus, a functional relationship between the heating energy needed for heating the temperature sensor and the mass flow through a pipeline, respectively through a measuring tube. The dependence of the heat transfer coefficient on the mass flow of the medium through the measuring tube, respectively through the pipeline, is utilized in thermal, flow measuring devices for determining the mass flow. Devices, which operate according to this principle, are manufactured and sold by the applicant under the marks ‘t trend’ and ‘t mass’.

To this point in time, mainly RTD elements with helically wound platinum wires have been applied in thermal, flow measuring devices. In the case of thin-film resistance thermometers (TFRTDs), conventionally, a meander-shaped platinum layer is vapor deposited on a substrate. On top of that, another glass layer is applied for protecting the platinum layer. The cross section of thin-film resistance thermometers is rectangular, in contrast with the round cross section of RTD elements. Heat transfer into the resistance element and/or from the resistance element occurs accordingly across two oppositely lying surfaces, which together make up a large part of the total surface area of a thin-film resistance thermometer.

The installation of a cuboid-shaped, thin-film resistance thermometer in a round pencil-shaped jacket is achieved in U.S. Pat. No. 6,971,274 and U.S. Pat. No. 7,197,953 in the following way. The thin-film resistance thermometer is so inserted into a spacer socket of metal having a rectangular recess that at least the two oppositely lying, large surfaces of the thin-film resistance thermometer have virtually gap-free contact with the surfaces of the spacer socket facing them. The spacer socket includes for this a rectangular recess, which is manufactured corresponding to the outer dimensions of the thin-film resistance thermometer. The spacer socket should tightly hold the thin-film resistance thermometer. In this regard, spacer socket and thin-film resistance thermometer have virtually a press fit. The spacer socket and the pencil-shaped jacket have likewise a press fit. In this way, the use of a potting compound or other type of fill material becomes unnecessary. The advantage of this construction is good heat transfer on all sides between thin-film resistance thermometer and measured medium through the spacer socket. However, mechanical stresses arise in the thin-film resistance thermometer due to the solid seating of the thin-film resistance thermometer and/or due to the different coefficients of thermal expansion of the participating materials.

DE 10 2009 028 848 A1 shows a spacer socket with a cavity for accommodating the thin-film resistance thermometer, which cavity is, however, so dimensioned that the thin-film resistance thermometer is solderable on a first surface of the spacer socket, wherein relative to a second surface, which lies opposite the first surface, it has a separation, which is large enough that fill material can be introduced into the spacer socket between thin-film resistance thermometer and second surface. The spacer socket has, in such case, a hole in the wall of the second surface, in order to be able to press the thin-film resistance thermometer through the hole by means of a hold-down onto the first surface of the spacer socket during the soldering step.

WO 2009/115452 A2 shows a spacer, which instead of a cavity in the form of a bore has a cavity in the form of a groove, wherein the thin-film resistance thermometer is solderable on the bottom of the groove. Since also this spacer is pressed into a pencil-shaped jacket, also here tightly neighboring groove sides can lead to stresses in the thin-film resistance thermometer.

An object of the invention is to provide a spacer for a thermal, flow measuring device supporting cost effective manufacture of the thermal, flow measuring device.

The object is achieved by the subject matter of independent claim 1. Further developments and embodiments of the invention are provided by the features of the respectively dependent claims.

Through an essentially lessened failure rate resulting from mechanical stresses and solder in the connection region of the cable, the thermal, flow measuring device of the invention is cost effective to manufacture.

The invention permits numerous forms of embodiment. Some thereof will now be explained in greater detail based on the appended drawing. Equal elements are provided in the figures with equal reference characters. The figures of the drawing show as follows:

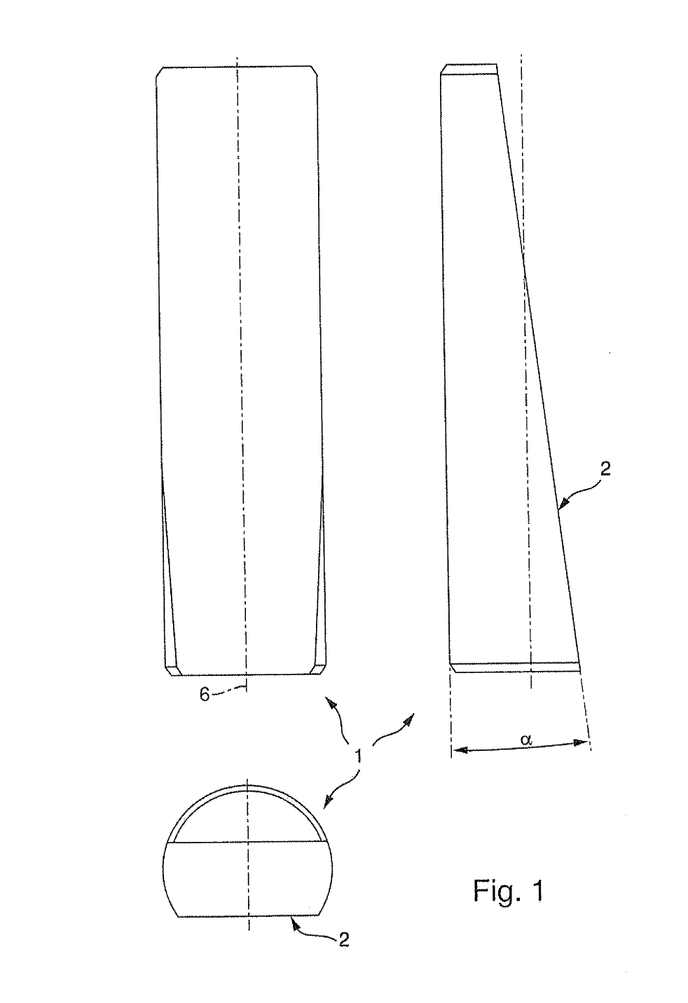

FIG. 1 a spacer of the invention in a first embodiment,

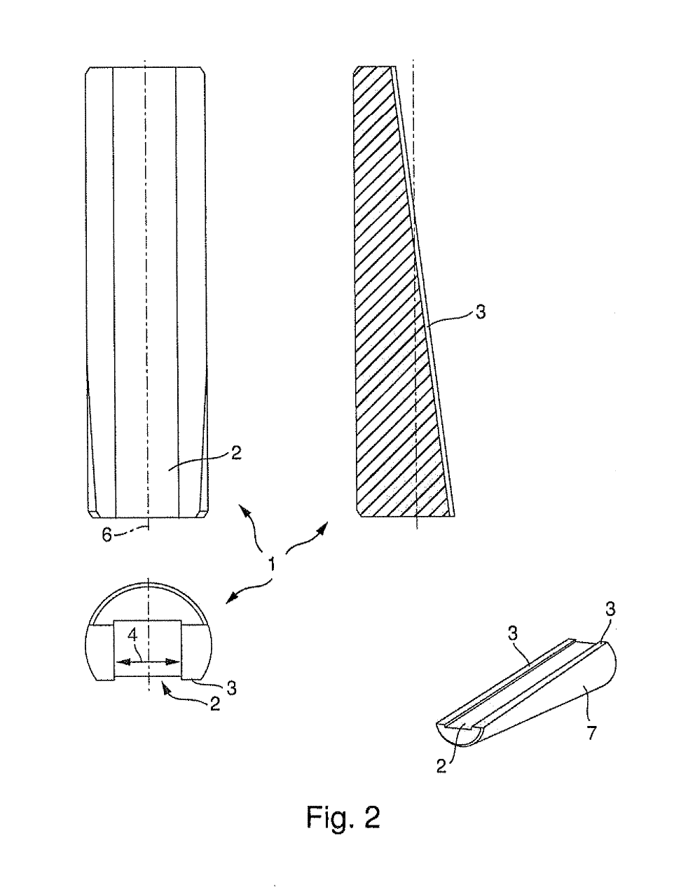

FIG. 2 a spacer of the invention in a second embodiment,

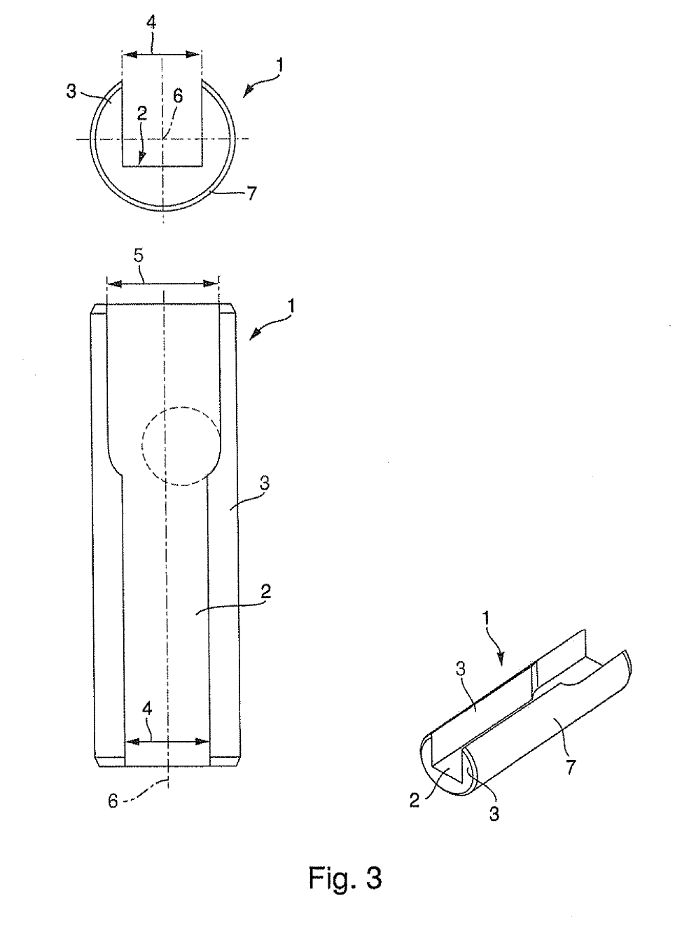

FIG. 3 a spacer of the invention in a third embodiment,

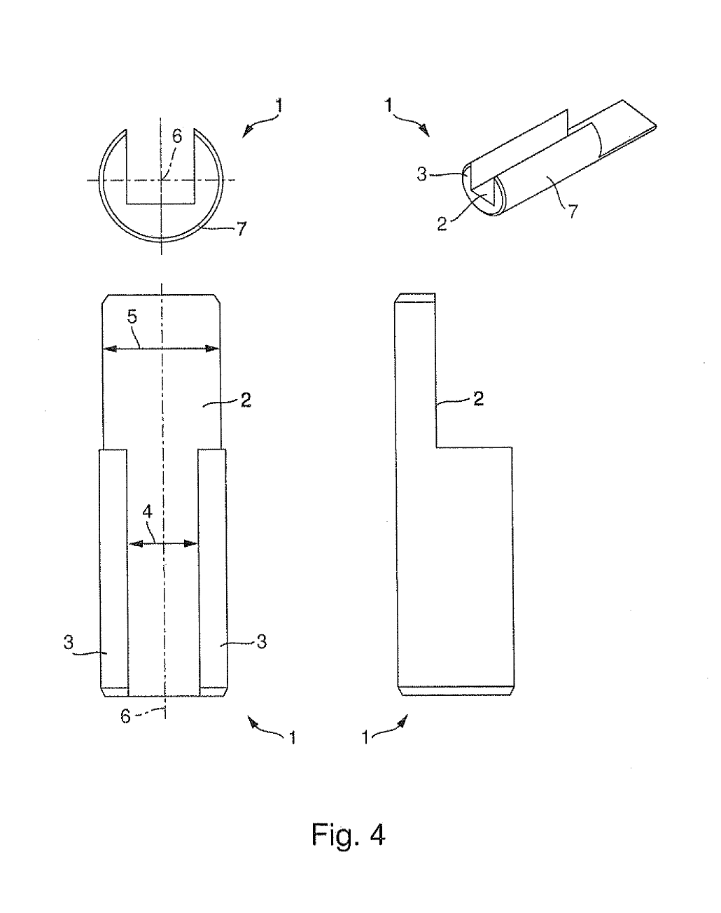

FIG. 4 a spacer of the invention in a fourth embodiment,

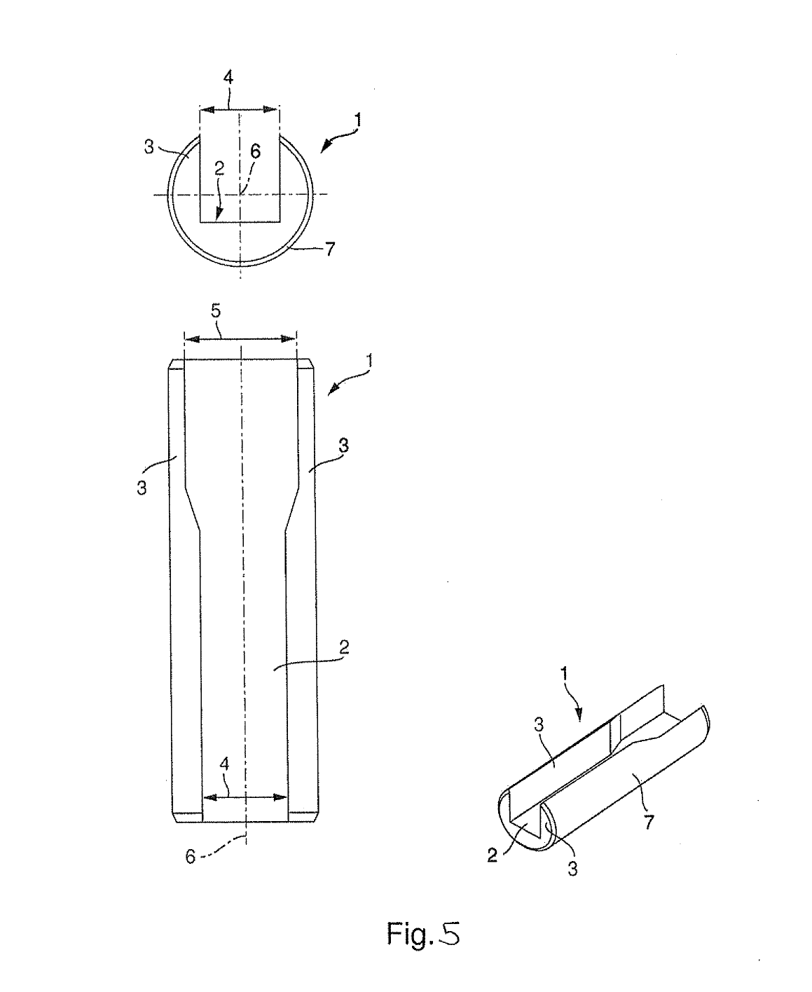

FIG. 5 a further spacer of the invention in a fifth embodiment.

FIG. 1 shows a spacer 1 of the invention for a thermal, flow measuring device. Spacer 1 has a planar bearing surface 2 and an otherwise circularly cylindrical, lateral surface 7 and is shown in front view, side view and plan view according to the conventions of technical drawing. Bearing surface 2 is inclined to the longitudinal axis 6 of the spacer. Longitudinal axis 6 lies, in such case, in an imaginary plane, which intersects the bearing surface 2 perpendicularly. Longitudinal axis 6 of the spacer 1 coincides, moreover, with a longitudinal axis of an imaginary circular cylinder having a lateral surface, which coincides with the circularly cylindrical, lateral surface of the spacer 1. It is, consequently, the imaginary rotational axis of the imaginary cylindrical lateral surface of the spacer without the planar bearing surface.

A cross section through the spacer 1 with a cutting plane perpendicular to the longitudinal axis of the spacer 1 yields a circular segment, wherein the otherwise circularly cylindrical, lateral surface 7 of the spacer 1 forms the circular arc and the bearing surface 2 forms the chord, which closes the circular segment.

An advantage of the invention is that excess solder in the case of the soldering of a thin-film resistance thermometer onto the bearing surface of the spacer can simply drain away.

In a further development of the spacer 1 of the invention, the longitudinal axis 6 of the spacer 1 projected perpendicularly into the planar bearing surface 2 and the longitudinal axis 6 of the spacer 1 enclose an angle α greater than 5°, especially greater than 10° and/or an angle α less than 30°, especially less than 20°.

The angle is correspondingly measured in the plane, which intersects the bearing surface 2 perpendicularly and which contains the longitudinal axis 6 of the spacer 1.

In the further development of the invention as sketched here, the planar bearing surface 2 forms a linear first edge 8 with a first end of the spacer 1. Edge 8 has a first separation measured perpendicularly to the lateral surface 7 and to the edge 8 and therewith lying in a plane perpendicular to the planar bearing surface 2, in which plane the longitudinal axis 6 of the spacer 1 lies, which first separation is greater than zero from the longitudinal axis of the spacer 1 and less than a separation of longitudinal axis 6 and lateral surface 7 of the spacer 1.

Spacer 1 has, furthermore, a linear second edge, which is a line of intersection of the planar bearing surface 2 and a second end of the spacer 1, which second edge has in the plane perpendicular to the planar bearing surface 2 and containing the longitudinal axis 6 of the spacer 1, a second separation from the lateral surface 7, which is greater than the separation of longitudinal axis 6 and lateral surface 7 of the spacer 1. Considered in cross section through the spacer, the first edge 8 lies below half of an imaginary circular cylinder with a lateral surface, which coincides with the circularly cylindrical, lateral surface 7 of the spacer 2, and the second edge lies above such half.

In the case of a thermal, flow measuring device of the invention with a spacer 1 of the invention and a thin-film resistance thermometer arranged on the bearing surface 2 of the spacer 1, the thin-film resistance thermometer is so arranged on the bearing surface 2 that connection cable of the thin-film resistance thermometer points away from the thin-film resistance thermometer toward the rising direction of the planar bearing surface 2 relative to the longitudinal axis 6 of the spacer.

The spacer 1 in FIG. 2 adds walls 3 bounding the bearing surface 2. The two walls 3 here limit the bearing surface 2 to a first width 4. In this way, a thin-film resistance thermometer can be held in position. The separation of the walls 3 from one another is constant over the entire length of the spacer 1. This can, however, vary over the length of the spacer. This will be explained below in greater detail. FIGS. 3 and 4 each show spacers 1 with flat bearing surfaces 2, which have no inclination relative to the longitudinal axis 6 of the spacer. However, their other geometric features are to be applied to the spacer of the invention. The planar bearing surface 2 is not inclined in these figures simply for reasons of simplifying the drawing.

If the planar bearing surface 2 is bounded by walls 3, such that the planar bearing surface 2 forms a groove bottom and the walls 3 groove sides of a groove, then the otherwise circularly cylindrical, lateral surface 7 of the spacer 1 forms, indeed, a circular arc in the cross section through the spacer 1, while a chord is, in contrast, no longer recognizable in the cross section. The cross sectional shape of the spacer 1 is a circular segment with geometric forms embodied by the cross sections of the walls 3 and 4 extending as chords to the bearing surface 2. Thus the outer contour of the spacer 1 includes the planar bearing surface 2, the form of the walls 3 and 4 bounding the spacer toward the environment and the otherwise circularly cylindrical, lateral surface 7.

If the planar bearing surface is, in contrast, bounded by walls, wherein the planar bearing surface and the walls form a bore, then the outer contour of the spacer is, in given cases, a circular cylinder.

If a spacer 1 of the invention has a planar bearing surface 2 with two different widths 4 and 5, then, according to an example of an embodiment, the first edge 8 has the first width and the second edge has the second width.

FIG. 3 shows a spacer 1 with a planar bearing surface 2 and an otherwise circularly cylindrical, lateral surface. Bearing surface 2 is inclined relative to the longitudinal axis 6 of the spacer. Longitudinal axis 6 lies, in such case, in an imaginary plane, which intersects the bearing surface 2 perpendicularly. Longitudinal axis 6 of the spacer 1 coincides, moreover, with a longitudinal axis of a circular cylinder with a lateral surface, which coincides with the circularly cylindrical, lateral surface of the spacer 2.

Found to be advantageous is an angle of inclination between the bearing surface 2 and the longitudinal axis 6 of the spacer 1 lying between 5° and 30°, especially between 10° and 20°. An advantage is that excess solder can drain in a predetermined direction. The application of an inclined bearing surface without limiting walls would mean that the thin-film resistance thermometer would not be held in its position by the walls. A combination of groove or bore and inclined bearing surface is advantageous for avoiding this problem.

FIG. 3 shows a spacer 1 of the invention for a thermal, flow measuring device in front view, in plan view and three dimensionally. Spacer 1 includes a groove following its longitudinal axis 6. The groove bottom forms a bearing surface 2 for a thin-film resistance thermometer. The groove sides are formed by the walls 3 of the spacer 1. The walls 3 have two different separations from one another. In a first region, the walls 3 have a first separation from one another and in a second region a second separation from one another. Since the walls 3 limit the width of the bearing surface 2 in this example of an embodiment over the entire length of the spacer 1, thus, the bearing surface 2 has in the first region a first width 4 and in the second region a second width 5, wherein, according to the invention, the first width 4 of the bearing surface 2 is less than the second width 5 of the bearing surface 2.

The first width 4 of the bearing surface 2 is, in such case, according to a further development of the invention, at least 10%, especially at least 20%, less than a second width 5 of the bearing surface 2. Since here the separations of the walls correspond to the width of the bearing surface 2, the walls 3 have in the region of the second width 5a, here by at least 10%, especially at least 20%, greater separation from one another than in the region of the first width 4.

A thermal, flow measuring device with a spacer 1 of the invention includes a thin-film resistance thermometer (not shown) arranged on the bearing surface 2 of the spacer 1. The thin-film resistance thermometer has two regions, a measuring region and a connection region. In the measuring region, a, most often meander shaped, platinum wire is arranged, while, in the connection region, most often, two connection pads are provided for the electrical connecting of the thin-film resistance thermometer with a voltage measuring device and/or an electrical current or voltage source for the heating.

According to the invention, the thin-film resistance thermometer is so arranged on the bearing surface 2 that, in the region of the connection cable to the thin-film resistance thermometer, thus in the connection region, the bearing surface has the second width 5, while the measuring region is arranged in the first region of the spacer 1 having the first width 4.

The spacer 1 is so embodied for the thin-film resistance thermometer that the second width 5 of the bearing surface 2 is at least 40% greater than, especially at least 60% greater than, a width of the thin-film resistance thermometer at the same position, thus especially in the connection region of the cable of the thin-film resistance thermometer. Here, thus, the separation of the walls 3 is correspondingly greater than the width of the thin-film resistance thermometer.

This has the technical effect that solder between bearing surface and thin-film resistance thermometer cannot during the soldering come between the thin-film resistance thermometer and the walls 3 and deposit on the thin-film resistance thermometer, especially in the connection region, where it could lead to short circuiting. The walls in the first region hold the thin-film resistance thermometer, however, in a predetermined position. A floating up of the thin-film resistance thermometer is, thus, not a problem.

Moreover, in the press-in procedure of the spacer into a pencil-shaped jacket, mechanical stresses are introduced into the spacer, which in the case of a spacer of the invention are held within predetermined limits and, thus, do not lead to damaging of the thin-film resistance thermometer.

In a further development of the invention, the first width of the bearing surface, thus especially the separation of the walls 3 in the first region, amounts to, at most, 115%, especially, at most, 105%, of the width of the thin-film resistance thermometer at the same position, here corresponding to the measuring region of the thin-film resistance thermometer.

A thermal, flow measuring device with a spacer of the invention is manufactured, for example, by applying solder between thin-film resistance thermometer and bearing surface of the spacer and orienting the thin-film resistance thermometer so on the bearing surface of the spacer that a two sided separation of the thin-film resistance thermometer in the region of the connection cable to the thin-film resistance thermometer from the boundaries of the bearing surface of the spacer amounts to at least 20% of the width of the thin-film resistance thermometer at the same position.

Then, the thin-film resistance thermometer is soldered onto the bearing surface of the spacer. In an embodiment of the invention, the spacer with the thin-film resistance thermometer soldered on is inserted, especially pressed, into a jacket, especially a pencil-shaped jacket.

The transition from first width 4 to second width 5 occurs here via a radius. However, other variants provide options, such as, for example, using a wedge shaped intermediate piece.

FIG. 4 shows an additional embodiment of the spacer 1. Here, spacer 1 has no walls bounding the bearing surface 2 in the second region. Also here, the separation of the walls corresponds to the first width 4 of the bearing surface 2. The thin-film resistance thermometer would correspondingly be so arranged on the bearing surface that the spacer 1 in the region of the connection cable to the thin-film resistance thermometer has no walls bounding the second width 5 of the bearing surface 2.

Alternatively to the here illustrated grooves, the walls can also limit a bore in the spacer, for example, a bore of rectangular cross section.

Alternatively for the solution of the invention, the ratio of groove width to groove depth is so adapted that the said mechanical stresses in the case of the pressing in of the spacer into the pencil-shaped jacket are reduced to a minimum. The groove depth could, in such case, for example, be so small that the solder in the case of the soldering extends over the groove edges and, thus, not over the region of the connection cable. Alternatively, the groove width is so large relative to the width of the thin-film resistance thermometer that excess solder does not flow between the thin-film resistance thermometer and the walls onto the thin-film resistance thermometer.

FIG. 5 shows a further spacer 1 of the invention for a thermal, flow measuring device in front view, plan view and perspectively presented. Spacer 1 in this case includes a groove following its longitudinal axis 6. The groove bottom forms a bearing surface 2 for a thin-film resistance thermometer. The groove sides are formed by the walls 3 of the spacer 1. The walls 3 have two different separations from one another. In a first region, the walls 3 have a first separation from one another and in a second region a second separation from one another. Since the walls 3 of the bearing surface 2 in this example of an embodiment limit width over the entire length of the spacer 1, the bearing surface 2 has in the first region a first width 4 and in the second region a second width 5, wherein according to the invention the first width 4 of the bearing surface 2 is less than a second width 5 of the bearing surface 2.

The first width 4 of the bearing surface 2 is, in such case, according to a further development of the invention, at least 15%, especially at least 20%, less than a second width 5 of the bearing surface 2. Since here the separations of the walls correspond to the widths of the bearing surface 2, the walls 3 in the region of the second width 5 have, here, an at least 15%, especially at least 20%, greater separation from one another than in the region of the first width 4.

### LIST OF REFERENCE CHARACTERS

1 spacer of a thermal, flow measuring device
2 bearing surface of the spacer for a thin-film resistance thermometer
3 walls of the spacer
4 first width of the bearing surface
5 second width of the bearing surface
6 longitudinal axis of the spacer
7 lateral surface of the spacer
8 edge

1-21. (canceled)

22. A spacer for a thermal, flow measuring device, wherein the spacer, comprises:
a planar bearing surface for a thin-film resistance thermometer and an otherwise circularly cylindrical, lateral surface, wherein:
said planar bearing surface is inclined relative to a longitudinal axis of the spacer.

23. The spacer as claimed in claim 22, wherein:
said longitudinal axis of the spacer projected perpendicularly into said planar bearing surface and said longitudinal axis of the spacer enclose an angle greater than 5°.

24. The spacer as claimed in claim 22, wherein:
said longitudinal axis of the spacer projected perpendicularly into said planar bearing surface and said longitudinal axis of the spacer enclose an angle less than 30°.

25. The spacer as claimed in claim 22, wherein:
said planar bearing surface forms with an end of the spacer a straight edge, which, in a plane perpendicular to said planar bearing surface, in which plane said longitudinal axis of the spacer lies, has a first separation from said lateral surface, which is less than the separation of said longitudinal axis from said lateral surface of the spacer.

26. The spacer as claimed in claim 22, wherein:
the spacer has two walls bounding a first width of said bearing surface.

27. The spacer as claimed in claim 26, wherein:
said first width of said bearing surface is less than a second width of said bearing surface.

28. The spacer as claimed in claim 27, wherein:
said first width of said bearing surface is at least 40% less than a second width of said bearing surface.

29. The spacer for a thermal, flow measuring device, especially a spacer as claimed in claim 22, comprising:
a bearing surface for a thin-film resistance thermometer and two walls bounding a first width of said bearing surface, wherein the first width of the bearing surface is less than a second width of said bearing surface.

30. The spacer as claimed in claim 29, wherein:
the first width of said bearing surface is at least 15% less than a second width of said bearing surface.

31. The spacer as claimed in claim 27, wherein:
the walls bound a groove in the spacer, whose groove bottom forms said bearing surface.

32. The spacer as claimed in claim 27, wherein:
the walls bound a bore in the spacer.

33. The spacer as claimed in claim 27, wherein:
the spacer has no walls in the region of the second width of the bearing surface.

34. The spacer as claimed in claim 27, wherein:
the walls in the region of said second width have a greater separation from one another than in the region of said first width.

35. The spacer as claimed in claim 29, wherein:
said bearing surface is inclined relative to said longitudinal axis of the spacer.

36. A thermal flow measuring device having a spacer as claimed in claim 22, and a thin-film resistance thermometer arranged on said bearing surface of the spacer, wherein:
said thin-film resistance thermometer is so arranged on said bearing surface that a connection cable of the thin-film resistance thermometer points away from the thin-film resistance thermometer in the rising direction of said planar bearing surface relative to said longitudinal axis of the spacer.

37. A thermal flow measuring device having a spacer as claimed in claim 22, and a thin-film resistance thermometer arranged on said bearing surface of the spacer, wherein:
said thin-film resistance thermometer is so arranged on said bearing surface that, in the region of connection cables to the thin-film resistance thermometer, said bearing surface has said second width.

38. The thermal flow measuring device as claimed in claim 37, wherein:
said thin-film resistance thermometer is so arranged on said bearing surface that the spacer has in the region of the connection cable to the thin-film resistance thermometer no walls limiting the width of said bearing surface, or the walls of the spacer have in the region of the connection cable to the thin-film resistance thermometer a separation from one another of at least 140% of a width of the thin-film resistance thermometer at the same position.

39. A thermal flow measuring device having a spacer as claimed in claim 22, and a thin-film resistance thermometer arranged on said bearing surface of the spacer, wherein:
said thin-film resistance thermometer is so arranged on said bearing surface that, in the region of connection cables to the thin-film resistance thermometer, said bearing surface has said second width.

40. The thermal flow measuring device as claimed in claim 39, wherein:
said thin-film resistance thermometer is so arranged on said bearing surface that the spacer has, in the region of the connection cable to said thin-film resistance thermometer, no walls limiting the width of said bearing surface, or the walls of the spacer have, in the region of the connection cable to said thin-film resistance thermometer, a separation from one another of at least 140% of a width of the thin-film resistance thermometer at the same position.

41. The thermal flow measuring device as claimed in claim 39, wherein:
said first width of said bearing surface amounts to, at most, 115% of the width of the thin-film resistance thermometer at the same position.

42. The method for the manufacture of a thermal, flow measuring device as claimed in claim 39, wherein:
the solder is applied between said thin-film resistance thermometer and said bearing surface of the spacer; and
said thin-film resistance thermometer is so oriented on said bearing surface of the spacer that a sum of the two side separations of the thin-film resistance thermometer in the region of the connection cable to said thin-film resistance thermometer from the bounds of said bearing surface of the spacer amounts to at least 140% of the width of the thin-film resistance thermometer at the same position.
